(19) United States
(12) Patent Application Publication
(10) Pub. No.: US 2026/0356044 A1
(43) Pub. Date: Nov. 12, 2026

(54) THREE-DIMENSIONAL PRINTING USING ROBOTICALLY CONTROLLED FLEXIBLE NOZZLES WITH ROLE-SWITCHING CAPABILITIES

(71) Applicant: International Business Machines Corporation, Armonk, NY (US)

(72) Inventors: Heather Nicole Polgrean, Lagrangeville, NY (US); Irving A. Duran, Dubuque, IA (US); Sarbajit Kumar Rakshit, Kolkata (IN); Carolina Garcia Delgado, Zapopan (MX)

(21) Appl. No.: 19/200,765

(22) Filed: May 7, 2025

(51) Int. Cl. B29C 64/393; B29C 64/209; B29C 64/336; B29C 64/379; B33Y 10/00; B33Y 30/00; B33Y 50/02

(52) U.S. Cl. CPC B29C 64/393; B29C 64/209; B29C 64/336; B29C 64/379; B33Y 10/00; B33Y 30/00; B33Y 50/02

(57) ABSTRACT

Methods for three-dimensional printing of a workpiece are provided. Aspects include obtaining a digital model of the workpiece, analyzing the digital model to determine geometric and material requirements of the workpiece, and assigning, based on the analysis, a functional role to each of a plurality of flexible robotic arms of a three-dimensional printing head, wherein the functional roles include at least one of a material extrusion role and a gripping role. Aspects also include actuating the flexible arms concurrently in accordance with their assigned roles to perform one or more of: depositing material onto a workpiece for forming a designated layer of the workpiece; engaging portions of the workpiece with a gripping mechanism to provide support to a portion of the workpiece; and repositioning the workpiece for subsequent material deposition.

### BACKGROUND

The present disclosure generally relates to the field of additive manufacturing, specifically to three-dimensional (3D) printing systems that employ robotically controlled flexible nozzles with role-switching capabilities.

Three-dimensional printing, also referred to as additive manufacturing, has developed into a transformative technology that enables the creation of intricate designs through layer-by-layer material deposition. This field encompasses applications across aerospace, healthcare, automotive, and consumer products, utilizing digital models and design software to guide the fabrication process. Recent progress in robotics, materials science, and process automation has expanded the range of possibilities by supporting higher precision and more adaptable production techniques. The incorporation of programmable motion control has provided enhanced management over deposition processes, paving the way for the production of objects with increasingly complex geometries. As the technology advances, the ongoing improvement of these systems remains important to addressing the growing demands of modern manufacturing.

### SUMMARY

Embodiments of the present disclosure are directed to computer-implemented methods for three-dimensional printing of a workpiece. According to an aspect, a computer-implemented method includes obtaining a digital model of the workpiece, analyzing the digital model to determine geometric and material requirements of the workpiece, and assigning, based on the analysis, a functional role to each of a plurality of flexible robotic arms of a three-dimensional printing head, wherein the functional roles include at least one of a material extrusion role and a gripping role. The computer-implemented method also includes actuating the flexible arms concurrently in accordance with their assigned roles to perform one or more of: depositing material onto a workpiece for forming a designated layer of the workpiece; engaging portions of the workpiece with a gripping mechanism to provide support to a portion of the workpiece; and repositioning the workpiece for subsequent material deposition.

Embodiments also include computer systems and computer program products for three-dimensional printing of a workpiece.

Embodiments also include an apparatus for three-dimensional printing includes a three-dimensional printing head with a plurality of flexible robotic arms, each robotic arm having multi-degree-of-freedom movement capabilities, where at least two of the flexible robotic arms are equipped with printing nozzles configured to deposit printing material onto a workpiece. The apparatus further includes a material supply system operatively coupled to the printing nozzles, designed to deliver one or more printing materials to the nozzles, and a control system operatively coupled to the three-dimensional printing head, the printing nozzles, and the material supply system. The control system is configured to manage the operation of the three-dimensional printing head and its components, and the apparatus incorporates a plurality of sensors to monitor the workpiece and environmental conditions surrounding the printing process.

Embodiments also include an apparatus for three-dimensional printing includes a three-dimensional printing head with a plurality of flexible robotic arms, each robotic arm having multi-degree-of-freedom movement capabilities, wherein the flexible robotic arms include a first flexible robotic arm with a first printing nozzle configured to deposit a first material onto a workpiece, a second flexible robotic arm with a second printing nozzle configured to deposit a second material onto the workpiece, and a third flexible robotic arm configured to grip the workpiece during the deposition of one or more of the first material and the second material. The apparatus further includes a multi-material handling system operatively coupled to the first and second printing nozzles, the multi-material handling system being configured to deliver the first material to the first printing nozzle and the second material to the second printing nozzle. Additionally, the apparatus includes a control system operatively coupled to the three-dimensional printing head, the printing nozzles, and the multi-material handling system, the control system being configured to control the operation of the three-dimensional printing head and its components. The apparatus also incorporates a plurality of sensors configured to monitor the workpiece and environmental conditions during the printing process.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a schematic block diagram illustrating the components of a three-dimensional printing device configured for dynamic role-switching and multi-material printing in accordance with one or more embodiments of the present disclosure;

FIG. 3A depicts a schematic diagram illustrating a 3D printing head equipped with flexible robotic arms for dynamic role-switching during additive manufacturing in accordance with one or more embodiments of the present disclosure;

FIG. 3B depicts a schematic system diagram of a 3D printing head with flexible robotic arms interacting with a workpiece in accordance with one or more embodiments of the present disclosure;

FIG. 4 depicts a system diagram of a 3D printing setup incorporating a 3D printing head, flexible robotic arms, and supporting components for advanced additive manufacturing in accordance with one or more embodiments of the present disclosure;

FIG. 5 depicts a schematic diagram of a flexible robotic arm configured for multi-functional operations in a 3D printing system in accordance with one or more embodiments of the present disclosure; and

FIG. 6 depicts a flowchart of a method for three-dimensional printing of a workpiece in accordance with one or more embodiments of the present disclosure.

### DETAILED DESCRIPTION

Embodiments of the present disclosure are directed to computer-implemented methods for three-dimensional printing of a workpiece. According to an aspect, a computer-implemented method includes obtaining a digital model of the workpiece, analyzing the digital model to determine geometric and material requirements of the workpiece, and assigning, based on the analysis, a functional role to each of a plurality of flexible robotic arms of a three-dimensional printing head, wherein the functional roles include at least one of a material extrusion role and a gripping role. The computer-implemented method also includes actuating the flexible arms concurrently in accordance with their assigned roles to perform one or more of: depositing material onto a workpiece for forming a designated layer of the workpiece; engaging portions of the workpiece with a gripping mechanism to provide support to a portion of the workpiece; and repositioning the workpiece for subsequent material deposition. The technical benefits of this embodiment include enhanced precision and efficiency in three-dimensional printing by dynamically assigning functional roles to flexible robotic arms based on the geometric and material requirements of the workpiece, enabling concurrent operations such as material deposition, workpiece stabilization, and repositioning, which reduce the need for supplemental support structures, minimize material waste, and improve the structural integrity of complex designs.

In addition to one or more of the features described herein the computer-implemented method also includes monitoring, via one or more sensors, spatial positioning of the plurality of flexible robotic arms and the workpiece during printing. The technical benefits of this embodiment include improved accuracy and reliability in the printing process by utilizing sensor-based monitoring to track the spatial positioning of the flexible robotic arms and the workpiece in real time, enabling dynamic adjustments to prevent misalignments, ensure precise material deposition, and reduce errors during fabrication.

In addition to one or more of the features described herein the computer-implemented method also includes dynamically adjusting the functional role assigned to at least one of the plurality of flexible robotic arms based on a detected change in the spatial positioning of the plurality of flexible robotic arms and the workpiece during printing. The technical benefits of this embodiment include enhanced adaptability and precision during the printing process by dynamically adjusting the functional roles of flexible robotic arms in response to detected changes in spatial positioning, ensuring real-time stabilization, accurate material deposition, and reduced risk of deformation or printing errors.

In addition to one or more of the features described herein the computer-implemented method also includes dynamically adjusting the functional role assigned to each of the plurality of flexible robotic arms during printing for each successive layer until completion of the workpiece. The technical benefits of this embodiment include improved efficiency and precision in the printing process by dynamically adjusting the functional roles of each flexible robotic arm for each successive layer, allowing the system to adapt to the evolving geometry and structural requirements of the workpiece, thereby ensuring optimal material deposition, stability, and overall print quality.

In addition to one or more of the features described herein engaging portions of the workpiece with the gripping mechanism reduces a need for supplemental support structures during printing. The technical benefits of this embodiment include reduced material waste and simplified post-processing by utilizing the gripping mechanism to dynamically stabilize portions of the workpiece during printing, thereby eliminating or minimizing the need for supplemental support structures.

In addition to one or more of the features described herein the analysis of the digital model further includes identifying regions of the workpiece that require temporary support during printing. The technical benefits of this embodiment include enhanced structural integrity and printing accuracy by analyzing the digital model to identify regions of the workpiece requiring temporary support, enabling dynamic stabilization during material deposition and reducing the need for disposable support structures.

In addition to one or more of the features described herein the computer-implemented method also includes assigning varying nozzle sizes to the flexible robotic arms to enable printing at resolutions tailored to different portions of the workpiece. The technical benefits of this embodiment include increased versatility and precision in the printing process by assigning varying nozzle sizes to the flexible robotic arms, allowing for tailored resolutions that accommodate intricate details and broader sections of the workpiece, thereby optimizing material deposition and overall print quality.

In addition to one or more of the features described herein the computer-implemented method also includes utilizing vision-based analytics to monitor printing and dynamically reassign a manipulation role to one or more of the flexible robotic arms for repositioning the workpiece based on a detected misalignment or deformation of the workpiece. The technical benefits of this embodiment include enhanced precision and error reduction during the printing process by utilizing vision-based analytics to detect misalignment or deformation in real time, enabling dynamic reassignment of manipulation roles to flexible robotic arms for repositioning the workpiece and ensuring accurate material deposition and structural integrity.

In addition to one or more of the features described herein the computer-implemented method also includes automatically reassigning the functional roles of the flexible robotic arms based on real-time analysis of stress patterns and deformation tendencies in the workpiece to enhance stabilization during printing. The technical benefits of this embodiment include improved stability and precision during the printing process by automatically reassigning the functional roles of flexible robotic arms based on real-time analysis of stress patterns and deformation tendencies, ensuring dynamic stabilization, reducing the risk of structural failures, and enhancing the quality of the final workpiece.

In addition to one or more of the features described herein the computer-implemented method also includes coordinating multi-material deposition by assigning material-specific extrusion roles to selected flexible robotic arms in accordance with the analyzed geometric and material requirements of the workpiece. The technical benefits of this embodiment include precise and efficient fabrication of complex objects by coordinating multi-material deposition, where material-specific extrusion roles are assigned to flexible robotic arms based on the analyzed geometric and material requirements, enabling seamless integration of diverse materials and reducing production time and waste.

Embodiments also include an apparatus for three-dimensional printing includes a three-dimensional printing head with a plurality of flexible robotic arms, each robotic arm having multi-degree-of-freedom movement capabilities, where at least two of the flexible robotic arms are equipped with printing nozzles configured to deposit printing material onto a workpiece. The apparatus further includes a material supply system operatively coupled to the printing nozzles, designed to deliver one or more printing materials to the nozzles, and a control system operatively coupled to the three-dimensional printing head, the printing nozzles, and the material supply system. The control system is configured to manage the operation of the three-dimensional printing head and its components, and the apparatus incorporates a plurality of sensors to monitor the workpiece and environmental conditions surrounding the printing process. The technical benefits of this embodiment include enhanced precision, adaptability, and efficiency in three-dimensional printing by utilizing flexible robotic arms with multi-degree-of-freedom movement for material deposition, a material supply system for seamless delivery of diverse printing materials, and a control system integrated with sensors to dynamically monitor and manage the printing process, ensuring optimal performance and reducing errors.

Embodiments also include an apparatus for three-dimensional printing includes a three-dimensional printing head with a plurality of flexible robotic arms, each robotic arm having multi-degree-of-freedom movement capabilities, wherein the flexible robotic arms include a first flexible robotic arm with a first printing nozzle configured to deposit a first material onto a workpiece, a second flexible robotic arm with a second printing nozzle configured to deposit a second material onto the workpiece, and a third flexible robotic arm configured to grip the workpiece during the deposition of one or more of the first material and the second material. The apparatus further includes a multi-material handling system operatively coupled to the first and second printing nozzles, the multi-material handling system being configured to deliver the first material to the first printing nozzle and the second material to the second printing nozzle. Additionally, the apparatus includes a control system operatively coupled to the three-dimensional printing head, the printing nozzles, and the multi-material handling system, the control system being configured to control the operation of the three-dimensional printing head and its components. The apparatus also incorporates a plurality of sensors configured to monitor the workpiece and environmental conditions during the printing process. The technical benefits of this embodiment include the ability to perform precise and efficient multi-material printing by utilizing flexible robotic arms with multi-degree-of-freedom movement, where specific arms are assigned to deposit different materials and others are configured to grip and stabilize the workpiece. The integration of a multi-material handling system ensures seamless delivery of diverse materials, while the control system and sensors enable real-time monitoring and management of the printing process, enhancing accuracy, reducing errors, and enabling the fabrication of complex, high-quality designs.

Increasingly, industries are seeking solutions that reduce production lead times, enhance precision, and minimize material waste, all while enabling the creation of highly detailed, customized products. The demand for manufacturing systems that can efficiently execute complex build tasks is particularly pronounced in sectors where both quality and resource conservation are of significant importance. Such systems aim to streamline the fabrication process by reducing or eliminating the need for additional support elements that are typically required during the printing of sophisticated structures. The objective is to achieve a harmonious balance between speed and accuracy while accommodating the varied requirements of products ranging from large-scale components to microscale devices. In this context, the pursuit of more adaptable and multifaceted manufacturing techniques represents an important goal for future technological advancements.

Existing methods in additive manufacturing often rely on fixed, rigid deposition mechanisms that require the use of supplemental support structures. These supports, while important for maintaining stability during fabrication, lead to increased material consumption, extended processing times, and challenging post-production cleanup. Such limitations become apparent when attempting to print objects with complex features such as overhangs, intricate internal structures, and curved surfaces. The conventional approach, defined by its sequential and inflexible nature, can result in inefficiencies that adversely affect productivity and cost management. Addressing these challenges remains a focus for researchers and engineers working to improve printing efficiency and minimize unnecessary waste, particularly as printing requirements grow more intricate and precise.

In more specific scenarios involving high-precision or micro-scale production, traditional additive manufacturing techniques encounter significant obstacles. As product designs become more sophisticated and the need for simultaneous material deposition and object stabilization increases, current systems struggle to meet these evolving requirements. The inability to dynamically adjust support and deposition strategies during the printing process often results in compromised structural integrity or imprecise feature formation. This limitation not only highlights the challenges associated with processing complex geometries but also drives the need for improved mechanisms that can adapt in real time to the specific nuances of each build.

The present system addresses these challenges by introducing a 3D printing setup equipped with an array of robotically controlled flexible nozzles capable of role-switching between multiple functions. Unlike traditional fixed nozzles, the flexible nozzles in this setup can dynamically adjust their positions, angles, and roles during the printing process, enabling them to function not only as extrusion mechanisms but also as robotic arms or grippers. This multi-functionality reduces the need for additional support structures, simplifies post-processing, and improves overall production efficiency. By leveraging intelligent role-switching capabilities, the setup adapts in real time to the geometry and material requirements of the object being printed, facilitating the fabrication of complex designs with minimal waste and high precision.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as three-dimensional printing using robotically controlled flexible nozzles with role-switching capabilities (block 150). In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 131, host physical machine set 142, virtual machine set 143, and container set 144.

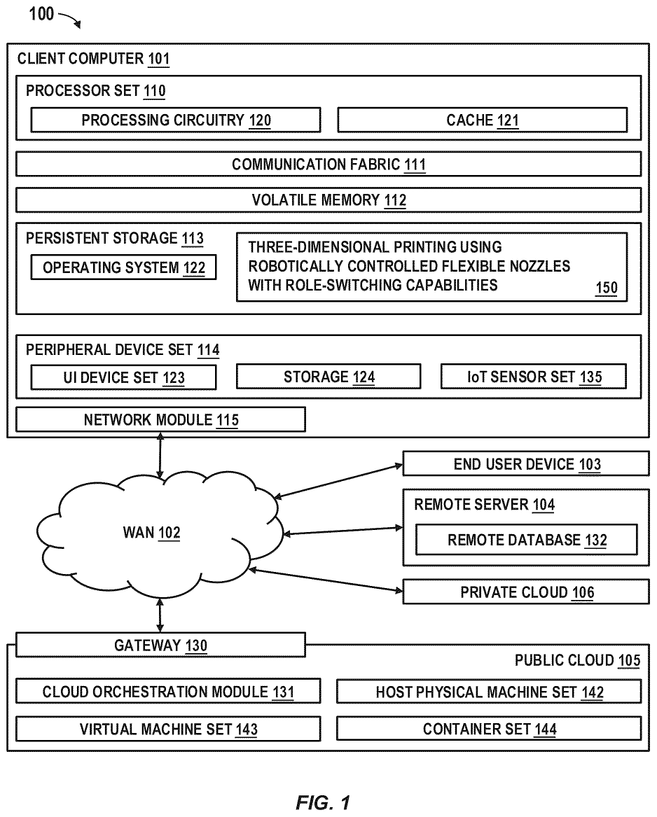

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

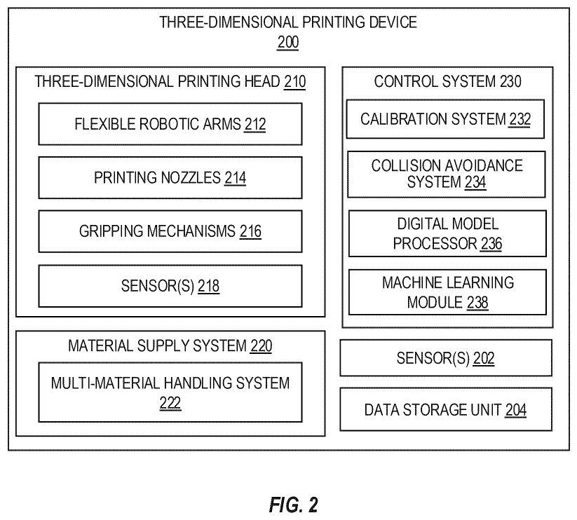

Referring now to FIG. 2, a block diagram of a three-dimensional printing device 200 in accordance with one or more embodiments of the present disclosure is shown. In one embodiment, the three-dimensional printing device 200 includes several interconnected components that collectively enable advanced additive manufacturing capabilities. Each component is designed to perform specific functions while interacting seamlessly with other components to ensure precision, efficiency, and adaptability during the printing process.

In exemplary embodiments, the three-dimensional printing head 210 serves as the operational unit of the three-dimensional printing device 200. The three-dimensional printing head 210 houses multiple subcomponents, including flexible robotic arms 212, printing nozzles 214, gripping mechanisms 216, and sensor(s) 218, all of which work collaboratively to execute complex printing tasks. The three-dimensional printing head 210 is designed to dynamically adapt to the geometry and material requirements of the object being printed, leveraging the integrated subcomponents to perform material deposition, object manipulation, and real-time adjustments. The three-dimensional printing head 210 is mechanically coupled to the material supply system 220 and electronically controlled by the control system 230, ensuring synchronized operations and efficient material handling.

In exemplary embodiments, the flexible robotic arms 212 are integrated into the three-dimensional printing head 210, providing multi-degree-of-freedom (DoF) movement capabilities. Each flexible robotic arm 212 is equipped with adjustable joints that can be either flexible or rigid, depending on the specific requirements of the printing task. In one embodiment, each of the flexible robotic arms 212 is capable of performing multiple roles, including material extrusion, gripping, and manipulation. In other embodiments, one or more of the flexible robotic arms 212 may be specifically configured to perform a subset of the material extrusion, gripping, and manipulation tasks.

The printing nozzles 214 of the flexible robotic arms 212 are configured to precisely deposit material on the workpiece, while simultaneously collaborating with the gripping mechanisms 216 of the flexible robotic arms 212 to stabilize or reposition the workpiece. The flexible robotic arms 212 are controlled by the control system 230, which dynamically assigns roles (material extrusion, gripping, and manipulation) to each of the flexible robotic arms 212 based on real-time analysis of the geometry and stress patterns of the workpiece. Sensor(s) 218 embedded within the flexible robotic arms 212 provide feedback on spatial positioning and force applied to/by the flexible robotic arms 212, enabling closed-loop control for enhanced accuracy.

In exemplary embodiments, the printing nozzles 214 are mounted on the distal end of the flexible robotic arms 212 and are responsible for extruding printing material onto the workpiece. In one embodiment, each printing nozzle 214 is capable of handling different materials, allowing for multi-material printing as facilitated by the multi-material handling system 222. The printing nozzles 214 may include adjustable apertures that control the rate at which the printing nozzles can deposit material onto the workpiece. The control system 230 coordinates the movements and operations of the printing nozzles 214, ensuring precise alignment and material deposition.

In exemplary embodiments, the gripping mechanisms 216 are integrated into the flexible robotic arms 212 and are designed to engage and secure portions of the workpiece during the printing process. The gripping mechanisms 216 can provide dynamic support for overhanging or intricate sections of the object, reducing the need for supplemental support structures. The gripping mechanisms 216 are equipped with sensor(s) 218 to monitor the applied force and ensure that the workpiece remains stable without deformation. The control system 230 dynamically assigns gripping roles to specific flexible robotic arms 212 based on the object's geometry and material requirements, enabling real-time adjustments during printing.

In exemplary embodiments, the sensor(s) 218 embedded within the three-dimensional printing head 210 and the associated subcomponents monitor spatial positioning, workpiece support conditions, and printing process parameters. These sensors 218 include proximity sensors, force sensors, and cameras, which provide real-time feedback to the control system 230. The sensor(s) 218 enable a closed-loop control mechanism to dynamically adjust the movements and roles of the flexible robotic arms 212, printing nozzles 214, and gripping mechanisms 216, ensuring high precision and minimizing errors during the printing process.

In exemplary embodiments, the material supply system 220 delivers printing material to the printing nozzles 214. The material supply system 220 is designed to handle a wide range of materials, including plastics, metals, and composites, ensuring compatibility with diverse manufacturing applications. The material supply system 220 may include a multi-material handling system 222, which enables the simultaneous delivery of multiple materials to different printing nozzles 214. The control system 230 monitors the material flow and adjusts the supply rate based on the object's design requirements and printing progress.

In exemplary embodiments, the multi-material handling system 222 is a subsystem within the material supply system 220 that facilitates the simultaneous use of different materials during the printing process. In one embodiment, each printing nozzle 214 is assigned specific materials based on the object's geometric and functional requirements. The multi-material handling system 222 ensures that the materials are delivered in the correct proportions and sequences, enabling the creation of complex, multi-material objects. The multi-material handling system 222 may include electrically actuated valves that can selectively connect the supply of various materials to desired printing nozzles. These valves allow precise control over material flow, ensuring that the appropriate material is routed to the correct nozzle at the right time during the printing process. The multi-material handling system 222 interacts with the digital model processor 236 to analyze the object's design and optimize material distribution, leveraging the electrically actuated valves to achieve efficient and accurate material delivery.

In exemplary embodiments, the control system 230 serves as the processing unit for the three-dimensional printing device 200, coordinating the operations of all subcomponents. The control system 230 dynamically assigns roles to the flexible robotic arms 212, printing nozzles 214, and gripping mechanisms 216 based on real-time analysis of the geometry and material requirements of the workpiece being created. The control system 230 integrates several subsystems, including a calibration system 232, a collision avoidance system 234, a digital model processor 236, and a machine learning module 238, to ensure precise and efficient printing. Sensor(s) 202 provide additional environmental data to the control system 230, enabling adaptive adjustments during the printing process.

In exemplary embodiments, the calibration system 232 maintains the accuracy and alignment of the flexible robotic arms 212 and printing nozzles 214. The calibration system 232 periodically adjusts the positions and movements of these components to compensate for wear, thermal expansion, or other factors that may affect performance. The calibration system 232 interacts with the sensor(s) 218 to gather data on spatial positioning and alignment, ensuring that the printing process remains precise and consistent.

In exemplary embodiments, the collision avoidance system 234 prevents interference between the flexible robotic arms 212, printing nozzles 214, and gripping mechanisms 216 during complex printing tasks. The collision avoidance system 234 uses data from the sensor(s) 218 and sensor(s) 202 to monitor the spatial positioning of all components and calculate optimal movement trajectories. The sensor(s) 202 may include one or more cameras that monitor the flexible robotic arms 212 and the workpiece, providing visual feedback to enhance spatial awareness and ensure precise coordination of movements. The collision avoidance system 234 is integrated with the control system 230, enabling real-time adjustments to prevent collisions and ensure smooth operations.

In exemplary embodiments, the digital model processor 236 analyzes the digital model of the object to be printed and generates a customized printing plan. The digital model processor 236 identifies regions requiring material deposition, temporary support, and manipulation, and assigns roles to the flexible robotic arms 212 and printing nozzles 214 accordingly. The digital model processor 236 interacts with the multi-material handling system 222 to determine the material requirements for each section of the object and optimize material distribution.

In exemplary embodiments, the machine learning module 238 enhances the adaptability and efficiency of the three-dimensional printing device 200 by analyzing historical data and real-time sensor feedback. The machine learning module 238 predicts potential issues, such as deformation or material inconsistencies, and adjusts the printing parameters to prevent errors. The machine learning module 238 interacts with the control system 230 and digital model processor 236 to continuously improve the printing process and ensure high-quality results.

In exemplary embodiments, the sensor(s) 202 are external sensors that monitor the environmental conditions surrounding the three-dimensional printing device 200. The sensor(s) 202 provide data on temperature, humidity, and other factors that may affect the printing process. The sensor(s) 202 interact with the control system 230 to enable adaptive adjustments based on environmental changes. The sensor(s) 202 may include one or more cameras that monitor the flexible robotic arms 212 and the workpiece, providing visual feedback to enhance spatial awareness and ensure precise coordination of movements.

In exemplary embodiments, the data storage unit 204 stores the digital models, printing plans, and historical data used by the three-dimensional printing device 200. The data storage unit 204 is operatively coupled to the digital model processor 236 and machine learning module 238, providing the necessary data for analysis and optimization. The data storage unit 204 ensures that the three-dimensional printing device 200 can access and utilize previous printing records to improve future operations.

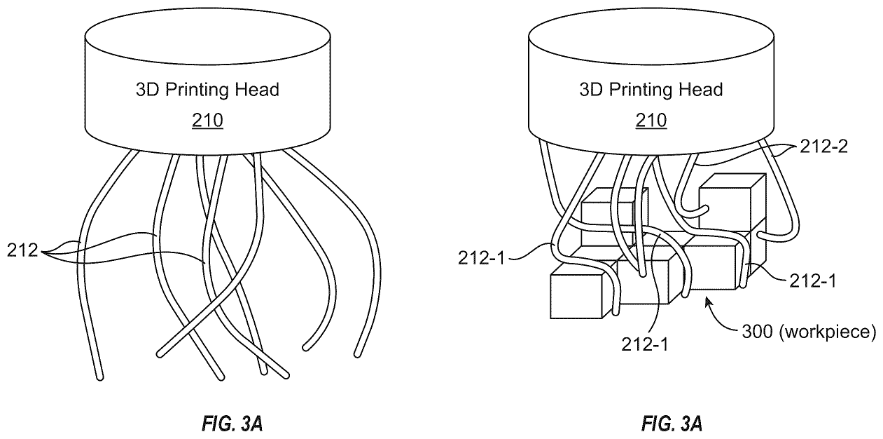

Referring now to FIG. 3A, a schematic diagram of 3D printing head 210 having a plurality of flexible robotic arms 212 in accordance with an embodiment is shown. The 3D printing head 210 serves as the central operational unit of the three-dimensional printing system. In exemplary embodiments, the 3D printing head 210 is designed to house and coordinate the operations of the flexible robotic arms 212, enabling precise and adaptable additive manufacturing. The 3D printing head 210 integrates advanced control mechanisms to dynamically assign roles to the flexible robotic arms 212 based on the geometric and material requirements of the object being printed. This adaptability allows the 3D printing head 210 to facilitate complex printing tasks with high efficiency and precision.

In exemplary embodiments, the flexible robotic arms 212 are multi-functional robotic arms that provide multi-degree-of-freedom movement capabilities. In one embodiment, each of the flexible robotic arms are capable of performing multiple roles, including material extrusion, gripping, and manipulation. The flexible robotic arms 212 are equipped with flexible joints that allow them to adjust their positions and angles dynamically, ensuring optimal alignment and interaction with the workpiece during the printing process. The flexible robotic arms 212 collaborate seamlessly with the 3D printing head 210 to execute intricate printing strategies tailored to the object's design.

Referring now to FIG. 3B, a three-dimensional printing system including a 3D printing head 210 and a workpiece 300 in accordance with an embodiment is shown. In exemplary embodiments, the 3D printing head 210 is designed to house and control the flexible robotic arms 212, enabling precise and adaptable additive manufacturing. The 3D printing system utilizes advanced control mechanisms to dynamically assign roles to the flexible robotic arms 212 based on the geometric and material requirements of the Workpiece 300. This adaptability allows the 3D printing head 210 to facilitate complex printing tasks with high efficiency and precision.

In exemplary embodiments, the workpiece 300 represents the object being fabricated during the printing process. The workpiece 300 is supported and manipulated by a first subset of the flexible robotic arms 212-1 to ensure optimal alignment and stability during material deposition by the second subset of the flexible robotic arms 212-2. The dynamic interaction between the workpiece 300 and the first and second subsets of the flexible robotic arms 212-1 and 212-2 enables the creation of intricate geometries without the need for supplemental support structures.

In exemplary embodiments, the first subset of flexible robotic arms 212-1 includes a set of flexible robotic arms mechanically coupled to the 3D printing head 210. These robotic arms are primarily responsible for gripping the workpiece to ensure optimal alignment and stability of the workpiece 300. The first subset of flexible robotic arms 212-1 provides dynamic support for overhanging or intricate sections of the workpiece 300, reducing the need for supplemental support structures. The first subset of flexible robotic arms 212-1 collaborates with the second subset of flexible robotic arms 212-2 to ensure seamless integration of material deposition and object stabilization. The second subset of flexible robotic arms 212-2 includes another set of flexible robotic arms mechanically coupled to the 3D printing head 210. These robotic arms are primarily responsible for depositing printing material onto the workpiece 300 to form successive layers.

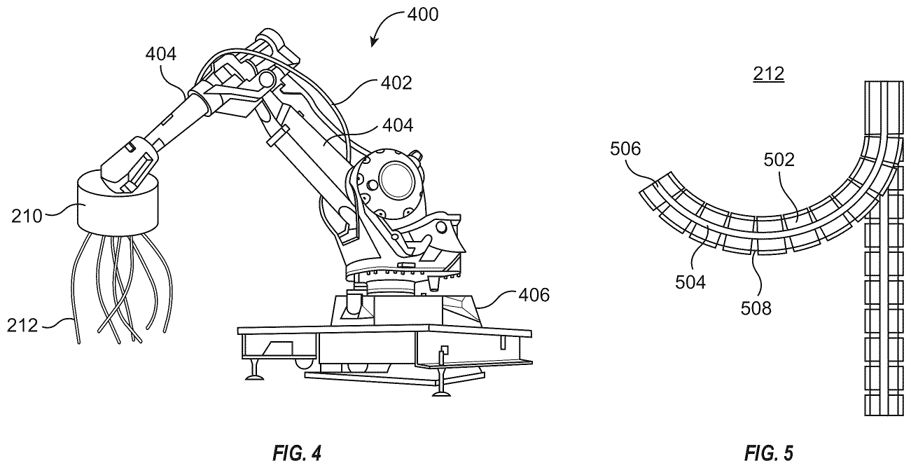

FIG. 4 shows a three-dimensional printing system including a 3D printing head 210, a flexible robotic arm 212, a printing head support device 400, a material supply conduit 402, rigid robotic arms 404, and a support platform 406. The three-dimensional printing is designed to facilitate advanced additive manufacturing processes by integrating these components to ensure precision, adaptability, and efficiency during the printing process.

In exemplary embodiments, the 3D printing head 210 serves as the central operational unit of the three-dimensional printing system, housing the flexible robotic arms 212 and enabling precise material deposition. The 3D printing head 210 is configured to dynamically adapt to the geometric and material requirements of the object being printed, leveraging the flexible robotic arms 212 for multi-functional operations such as material extrusion, gripping, and manipulation.

In exemplary embodiments, the flexible robotic arms 212 are mechanically coupled to the 3D printing head 210 and provide multi-degree-of-freedom movement capabilities. The flexible robotic arms 212 include flexible joints that allow dynamic adjustments in position and angle, promoting effective alignment and interaction with the workpiece 300 during the printing process. The flexible robotic arms 212 work in conjunction with other system components, such as the printing head support device 400 and the material supply conduit 402, to carry out complex printing strategies tailored to the object's design.

In exemplary embodiments, the printing head support device 400 provides structural support and stability to the 3D printing head 210 and the associated components of the 3D printing head 210. This configuration ensures that the 3D printing head 210 remains securely positioned during operation, allowing for precise and consistent material deposition. The printing head support device 400 is mechanically connected to a rigid robotic arm 404, which facilitates controlled movement and positioning of the 3D printing head 210.

In exemplary embodiments, the material supply conduit 402 is integrated into the three-dimensional printing system to deliver printing material to the 3D printing head 210. The material supply conduit 402 is designed to handle a variety of materials, supporting compatibility with diverse manufacturing applications. The material supply conduit 402 facilitates a continuous and controlled flow of material to maintain the quality and accuracy of the printed object.

In exemplary embodiments, the rigid robotic arm 404 is a rigid, mechanically controlled arm that provides robust support and precise movement for the 3D printing head 210. These arms are responsible for positioning the 3D printing head 210 and maintaining stability during the printing process. One or more rigid robotic arms 404 may work in conjunction with the printing head support device 400 to ensure seamless operation and adaptability to various printing tasks.

In exemplary embodiments, the support platform 406 serves as the base for the three-dimensional printing system, providing a stable foundation for the printing head support device 400 and the rigid robotic arm 404. The support platform 406 is designed to absorb vibrations and maintain the overall stability of the system, ensuring high precision and reliability during the printing process.

Referring now to FIG. 5, a flexible robotic arm 212 configured for multi-functional operations in a three-dimensional printing system in accordance with an embodiment is shown. The flexible robotic arm 212 includes a plurality of flexible robotic arm sections 502, a material supply conduit 504, a printing nozzle 506, and joints 508. These components collectively enable the flexible robotic arm 212 to perform tasks such as material extrusion, gripping, and manipulation during the additive manufacturing process.

In exemplary embodiments, the flexible robotic arm sections 502 form the structural framework of the flexible robotic arm 212, providing flexibility and multi-degree-of-freedom movement capabilities. The flexible robotic arm sections 502 are designed to adapt to various positions and angles, via the joints 508 that connect adjacent flexible robotic arm sections 502, allowing the flexible robotic arm 212 to interact effectively with the workpiece 300 and other system components.

In exemplary embodiments, the joints 508 are positioned between adjacent flexible robotic arm sections 502 along the flexible robotic arm 212 to provide flexibility and articulation of the flexible robotic arm 212. The joints 508 allow the flexible robotic arm 212 to adjust movements dynamically, promoting effective alignment and interaction with the workpiece. These joints 508 are engineered to maintain stability and precision during the printing process, even under varying load conditions. In exemplary embodiments, the control system is configured to individually actuate the joints 508 to control the articulation of the flexible robotic arm 212.

In exemplary embodiments, the material supply conduit 504 is integrated within the flexible robotic arm 212 to deliver printing material to the printing nozzles 506. For example, the material supply conduit 504 may be disposed through central apertures of each of the flexible robotic arm sections 502. The material supply conduit 504 is designed to handle a variety of materials, supporting compatibility with diverse manufacturing applications. The material supply conduit 504 facilitates a continuous and controlled flow of material, ensuring consistent quality and accuracy during the printing process.

In exemplary embodiments, a printing nozzle 506 is mounted on the distal end of the flexible robotic arm 212 and is responsible for extruding printing material onto the workpiece. In one embodiment, each printing nozzle 506 is capable of handling different materials, enabling multi-material printing. In one embodiment, the printing nozzles 506 are designed with adjustable apertures to control the rate of material deposition, ensuring precise alignment and layer formation.

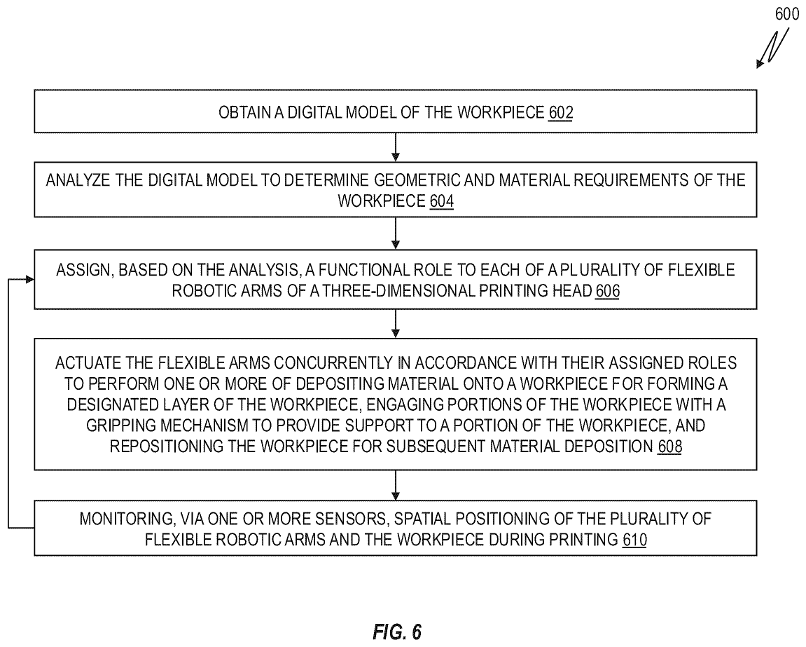

Referring now to FIG. 6, a flowchart of a method for three-dimensional printing of a workpiece in accordance with one or more embodiments of the present disclosure is shown. In one embodiment, the method 600 is performed by a three-dimensional printing device 200 such as the one shown in FIG. 2. At block 602, the method 600 includes obtaining a digital model of the workpiece. The digital model of the workpiece serves as the foundational blueprint for the three-dimensional printing process. The digital model is typically created using computer-aided design (CAD) software or other 3D modeling tools. The digital model contains detailed geometric and material specifications of the workpiece, including dimensions, structural features, and material composition. The digital model is stored in a compatible file format, such as STL or OBJ, which can be processed by the three-dimensional printing device 200. In exemplary embodiments, the digital model is transmitted to the control system 230, where the model is analyzed and used to guide the subsequent steps of the printing process.

Once the digital model is obtained, the control system 230 analyzes the digital model to determine the geometric and material requirements of the workpiece, as shown at block 604. This analysis is performed by the digital model processor 236, which evaluates the digital model to identify regions requiring material deposition, temporary support, and manipulation. The analysis includes assessing the geometric complexity of the workpiece, such as overhangs, intricate internal structures, and curved surfaces, as well as the material properties required for each section. In exemplary embodiments, the digital model processor 236 interacts with the multi-material handling system 222 to determine the material requirements for each section of the workpiece, ensuring that the appropriate materials are selected and distributed efficiently. This step optimizes the printing strategy and ensures that the workpiece is fabricated with high precision and minimal waste.

Next, as shown at block 606, the method 600 includes assigning, based on the analysis, a functional role to each of a plurality of flexible robotic arms of a three-dimensional printing head. In one embodiment, based on the analysis of the digital model, the control system 230 assigns a functional role to each of a plurality of flexible robotic arms 212 of the three-dimensional printing head 210. The functional roles include material extrusion, workpiece gripping, and workpiece manipulation. In exemplary embodiments, the flexible robotic arms 212 are dynamically assigned roles to adapt to the specific requirements of the workpiece. For example, some flexible robotic arms 212 may be designated for depositing material onto the workpiece, while others may be assigned to grip and stabilize portions of the workpiece or manipulate the position of the workpiece for subsequent material deposition. In exemplary embodiments, the role assignment is performed in real-time and can be adjusted dynamically during the printing process to accommodate changes in the workpiece geometry or material requirements. This capability is enabled by the machine learning module 238, which uses historical data and real-time sensor feedback to optimize the role assignments and ensure efficient and accurate printing.

Next, as shown at block 608, the method 600 includes actuating the flexible robotic arms concurrently in accordance with their assigned roles to perform one or more of depositing material onto a workpiece for forming a designated layer of the workpiece, engaging portions of the workpiece with a gripping mechanism to provide support to a portion of the workpiece, and repositioning the workpiece for subsequent material deposition. In exemplary embodiments, the flexible robotic arms 212 are actuated concurrently in accordance with their assigned roles to perform one or more tasks, including depositing material onto the workpiece for forming a designated layer of the workpiece, engaging portions of the workpiece with a gripping mechanism 216 to provide support to a portion of the workpiece, and repositioning the workpiece for subsequent material deposition. In exemplary embodiments, the control system 230 coordinates the movements and operations of the flexible robotic arms 212, ensuring that each flexible robotic arm 212 performs its assigned role with high precision and efficiency. The printing nozzles 214, mounted on the distal ends of the flexible robotic arms 212, are responsible for extruding the printing material onto the workpiece. The gripping mechanisms 216, integrated into the flexible robotic arms 212, engage and secure portions of the workpiece to provide dynamic support for overhanging or intricate sections. The flexible robotic arms 212 also manipulate the workpiece to optimize alignment and positioning for subsequent material deposition. This concurrent actuation of the flexible robotic arms 212 enables the creation of complex geometries without the need for supplemental support structures, reducing material waste and improving production efficiency.

The method 600 also includes monitoring, via one or more sensors, spatial positioning of the plurality of flexible robotic arms and the workpiece during printing, as shown at block 610. In one embodiment, the spatial positioning of the plurality of flexible robotic arms 212 and the workpiece is monitored during printing via one or more sensors 218. These sensors 218 include proximity sensors, force sensors, and cameras, which provide real-time feedback to the control system 230. The sensor data is used to track the movements and positions of the flexible robotic arms 212 and the workpiece, ensuring that the printing process remains precise and error-free. The control system 230 uses this feedback to dynamically adjust the movements and roles of the flexible robotic arms 212, correcting any misalignments or deviations detected during the printing process. The closed-loop control mechanism enabled by the sensors 218 ensures high precision and minimizes errors, resulting in a high-quality final product. The monitoring process also facilitates collision avoidance, as the collision avoidance system 234 calculates optimal movement trajectories for the flexible robotic arms 212 to prevent interference and ensure smooth operations.

In one embodiment, the flexible robotic arms are equipped with interchangeable nozzles of varying sizes, allowing for dynamic adjustments to the resolution of material deposition based on the geometric complexity of the workpiece. For example, smaller nozzles may be used for intricate details requiring high precision, while larger nozzles may be employed for faster deposition of bulk material. In another embodiment, the flexible robotic arms are configured to handle different types of materials, such as thermoplastics, metals, ceramics, or composite materials, enabling multi-material printing within a single operation. Each arm may be equipped with specialized extrusion mechanisms tailored to the viscosity, melting point, or other material-specific properties.

In one embodiment, the robotic arms are designed with varying degrees of freedom, ranging from simple linear movements to complex multi-axis articulation, allowing for enhanced adaptability to diverse workpiece geometries, such as overhangs, curved surfaces, or internal cavities. Additionally, the gripping mechanisms integrated into the arms may vary in design, such as suction-based grips, mechanical clamps, or magnetic attachments, depending on the material and structural requirements of the workpiece.

In one embodiment, the system incorporates advanced sensor arrays, including proximity sensors, force sensors, and cameras, to monitor the spatial positioning and alignment of the arms and the workpiece, ensuring precise coordination during role-switching. The control system may also utilize machine learning algorithms to predict deformation tendencies and dynamically reassign roles to the arms in real time, optimizing the printing process for complex objects. Moreover, the flexible robotic arms may be configured to operate in collaborative clusters, where subsets of arms are dedicated to specific tasks, such as simultaneous multi-material extrusion and stabilization, enabling faster and more efficient production of intricate designs.

In exemplary embodiments, the process of dynamically adjusting the functional role assigned to at least one of the plurality of flexible robotic arms involves real-time analysis of spatial positioning data collected during the printing process. This adjustment is facilitated by a sensor array integrated into the robotic arms and the control system, which continuously monitors the relative positions of the arms and the workpiece. For example, if a sensor detects that a portion of the workpiece is beginning to tilt or deform due to uneven material deposition, the control system can reassign the role of one robotic arm from material extrusion to gripping. This arm would then stabilize the workpiece by applying a calculated amount of force to counteract the deformation. Concurrently, other arms may continue their extrusion tasks to maintain the printing process without interruption. This dynamic role-switching ensures that the printing operation adapts to unforeseen changes in the workpiece geometry, thereby improving precision and reducing the likelihood of errors or defects. For instance, during the fabrication of a complex overhanging structure, one arm may initially be assigned to extrude material, but upon detecting a shift in the workpiece's alignment, it could switch to a gripping role to provide temporary support until the structure stabilizes.

In exemplary embodiments, the process of dynamically adjusting the functional role assigned to each of the plurality of flexible robotic arms during printing for each successive layer ensures that the system adapts to the evolving geometry and structural requirements of the workpiece. This is achieved through real-time analysis of the digital model and sensor feedback, which allows the control system to reassign roles such as material extrusion, gripping, or manipulation to the robotic arms as needed. For example, during the printing of a multi-layered object with intricate overhangs, the control system may initially assign certain arms to extrude material for the base layer while others stabilize the workpiece. As the printing progresses to higher layers, the system may reassign some gripping arms to extrusion roles to handle finer details, while other arms switch to manipulation roles to smooth surfaces or adjust layer alignment. This continuous role adjustment for each successive layer ensures optimal precision, stability, and efficiency throughout the printing process. For instance, when printing a curved structure, the arms may dynamically alternate between supporting the overhangs and depositing material to maintain the integrity of the design without requiring supplemental support structures.

In exemplary embodiments, engaging portions of the workpiece with the gripping mechanism are designed to reduce or eliminate the need for supplemental support structures during the printing process. This functionality is achieved by utilizing flexible robotic arms equipped with gripping mechanisms to provide dynamic, real-time stabilization to the workpiece. The gripping mechanisms can secure overhanging or intricate sections of the object, preventing deformation or collapse as material is deposited. For example, during the fabrication of a complex object with extended overhangs, the control system may assign one or more robotic arms to grip and stabilize the overhanging sections while other arms continue extruding material to build successive layers. This approach eliminates the need to print disposable support structures, which would otherwise require additional material and post-processing for removal. For instance, when printing a hollow sphere with a narrow base, the gripping mechanisms can hold the sphere in place as the base solidifies, ensuring structural integrity without the need for external supports. This method not only improves efficiency but also minimizes material waste and simplifies post-production cleanup.

In exemplary embodiments, the analysis of the digital model to identify regions of the workpiece that require temporary support during printing involves evaluating the geometric and structural characteristics of the object to be fabricated. This process is typically performed by the control system, which uses advanced algorithms, such as finite element analysis, to simulate the behavior of the workpiece under various printing conditions. The analysis considers factors such as overhangs, sharp corners, large spans, and areas prone to deformation due to stress or gravity. For example, when printing a complex object with a cantilevered section, the system may identify the overhanging region as requiring temporary stabilization. Based on this analysis, the control system assigns one or more flexible robotic arms to provide dynamic support by gripping or bracing the identified region during material deposition. Once the section is sufficiently stabilized by subsequent layers, the robotic arms can release the support and switch to other roles, such as material extrusion or manipulation. This approach ensures the structural integrity of the workpiece while minimizing the need for disposable support structures, thereby reducing material waste and post-processing requirements.

In exemplary embodiments, utilizing vision-based analytics to monitor printing enables the system to dynamically reassign a manipulation role to one or more of the flexible robotic arms when misalignment or deformation of the workpiece is detected. This process involves the use of cameras and other vision sensors integrated into the 3D printing system to continuously capture real-time data on the spatial positioning and structural integrity of the workpiece. The control system analyzes this data to identify any deviations from the intended alignment or geometry. For example, if the vision-based system detects that a section of the workpiece has shifted due to uneven material deposition or external forces, it can reassign one of the robotic arms from its current role, such as material extrusion, to a manipulation role. The reassigned arm can then gently reposition the workpiece to restore proper alignment, ensuring that subsequent layers are deposited accurately. For instance, during the printing of a tall, slender structure, if the workpiece begins to tilt, the system can dynamically assign a robotic arm to stabilize and reposition the structure, preventing further misalignment and ensuring the integrity of the final product. This capability enhances precision, reduces errors, and minimizes the need for reprints.

In exemplary embodiments, automatically reassigning the functional roles of the flexible robotic arms based on real-time analysis of stress patterns and deformation tendencies in the workpiece ensures enhanced stabilization during the printing process. This functionality is achieved through the integration of sensor arrays and advanced algorithms that continuously monitor the workpiece for stress concentrations and deformation risks. The control system analyzes data from proximity sensors, force sensors, and cameras to detect areas of the workpiece that may be prone to instability or structural compromise. For example, if the system identifies a region of the workpiece experiencing excessive stress due to an overhang or uneven material deposition, it can dynamically reassign one or more robotic arms from extrusion roles to gripping roles. These arms would then stabilize the affected region by applying calculated forces to counteract the stress and prevent deformation. Concurrently, other arms may continue their extrusion tasks to maintain the printing process without interruption. For instance, during the fabrication of a cantilevered structure, the system may detect bending tendencies in the overhanging section and reassign a robotic arm to grip and support the area until additional layers are deposited to reinforce it. This real-time role adjustment ensures the structural integrity of the workpiece, reduces errors, and minimizes the need for reprints or post-processing corrections.

In exemplary embodiments, coordinating multi-material deposition by assigning material-specific extrusion roles to selected flexible robotic arms ensures precise and efficient fabrication of complex objects with varying material requirements. This process begins with the control system analyzing the geometric and material specifications of the digital model to determine which sections of the workpiece require specific materials. Based on this analysis, the system dynamically assigns extrusion roles to individual robotic arms, each equipped to handle different materials. For example, during the printing of a composite object with both rigid and flexible sections, one robotic arm may be assigned to extrude a high-strength polymer for structural support, while another arm deposits a flexible elastomer for areas requiring pliability. The control system synchronizes the movements and operations of these arms to ensure seamless integration of the materials, maintaining alignment and layer consistency. For instance, when printing a medical device such as a prosthetic limb, the system may assign one arm to deposit a lightweight composite for the outer shell while another arm extrudes a softer material for internal cushioning. This coordinated multi-material deposition enables the creation of intricate, functional designs tailored to specific applications, reducing waste and improving production efficiency.

In exemplary embodiments, the 3D printing head disclosed herein can be used to address challenges in printing microarchitectures and nanotechnology applications, particularly in fields such as metallurgical printing and biomedical engineering. Traditional 3D printing systems struggle to produce intricate designs at micro and nano scales due to limitations in precision and the difficulty of removing support structures for tiny patterns. The 3D printing head disclosed introduces flexible robotic arms with role-switching capabilities, enabling precise manipulation and stabilization of delicate structures during the printing process. For example, the system could be used to fabricate complex microstructures like heart valves, which are currently woven by hand due to their intricate nature. By approximating the dexterity and adaptability of human hands, the 3D printing head with a plurality of flexible robotic arms allows for the creation of highly detailed components without imperfections, such as fingerprints, while reducing waste and improving efficiency. This capability opens new possibilities for practical manufacturing applications in nanotechnology and micro-scale designs, addressing a critical gap in current additive manufacturing technologies.

In exemplary embodiments, during the printing of a workpiece, multiple different materials can be simultaneously deposited on different portions of the workpiece by different flexible robotic arms. One example of printing a workpiece using simultaneous deposition of two different materials involves the fabrication of a composite medical device, such as a prosthetic limb. The digital model of the prosthetic limb specifies two distinct material requirements: a lightweight, rigid polymer for the outer shell to provide structural support and a softer, flexible elastomer for the internal cushioning to enhance comfort. During the printing process, the control system analyzes the geometric and material requirements of the workpiece and assigns specific extrusion roles to two flexible robotic arms. The first robotic arm, equipped with a nozzle designed for high-strength polymer extrusion, deposits the rigid material onto the outer shell of the prosthetic limb, ensuring the structural integrity of the design. Simultaneously, the second robotic arm, equipped with a nozzle optimized for elastomer deposition, extrudes the softer material into the internal cavities of the workpiece to form the cushioning layer. The control system synchronizes the movements of both arms, ensuring precise alignment and seamless integration of the two materials. For instance, while the first arm is depositing the polymer to form the outer shell of the limb, the second arm dynamically adjusts its position to fill the internal cavities with the elastomer, ensuring that the cushioning layer adheres properly to the rigid shell. This coordinated multi-material deposition allows the prosthetic limb to be fabricated in a single operation, reducing production time and eliminating the need for post-processing steps to combine the materials. The result is a functional, high-quality medical device tailored to the specific needs of the user.

In exemplary embodiments, an apparatus for three-dimensional printing incorporates advanced control systems to ensure precision, efficiency, and adaptability during the printing process. The control system includes a calibration system designed to maintain alignment and accuracy of the flexible robotic arms and printing nozzles, compensating for factors such as wear or thermal expansion. A collision avoidance system is integrated to prevent interference between the flexible robotic arms, printing nozzles, and gripping mechanisms, ensuring smooth and uninterrupted operations. The apparatus further includes a digital model processor that analyzes the geometric and material requirements of the workpiece and generates a customized printing plan tailored to the object's design. Additionally, a machine learning module enhances the system's adaptability by predicting potential printing issues, such as deformation or material inconsistencies, and dynamically adjusting printing parameters based on real-time sensor feedback. These features collectively enable the apparatus to perform complex printing tasks with high precision, reduce errors, and optimize the overall printing process for intricate and multi-material designs.

In exemplary embodiments, an apparatus for three-dimensional printing includes sensors embedded within the flexible robotic arms to enhance precision and control during the printing process. These embedded sensors are configured to monitor spatial positioning, applied forces, and printing process parameters in real time. By continuously collecting and transmitting data to the control system, the sensors enable dynamic adjustments to the movements and roles of the robotic arms, ensuring accurate material deposition and stabilization of the workpiece. For example, the sensors can detect misalignments or deformation tendencies in the workpiece and provide feedback to the control system to reassign roles or modify printing trajectories. This real-time monitoring capability improves the reliability and efficiency of the printing process, reduces errors, and ensures the structural integrity of complex designs, making the apparatus particularly suitable for applications requiring high precision and adaptability.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for three-dimensional printing of a workpiece, the method comprising:
obtaining a digital model of the workpiece;
analyzing the digital model to determine geometric and material requirements of the workpiece;
assigning, based on the analysis, a functional role to each of a plurality of flexible robotic arms of a three-dimensional printing head, wherein the functional roles include at least one of a material extrusion role and a gripping role; and
actuating the flexible arms concurrently in accordance with their assigned roles to perform one or more of:
depositing material onto a workpiece for forming a designated layer of the workpiece;
engaging portions of the workpiece with a gripping mechanism to provide support to a portion of the workpiece, and
repositioning the workpiece for subsequent material deposition.

2. The computer-implemented method of claim 1, further comprising:
monitoring, via one or more sensors, spatial positioning of the plurality of flexible robotic arms and the workpiece during printing.

3. The computer-implemented method of claim 2, further comprising:
dynamically adjusting the functional role assigned to at least one of the plurality of flexible robotic arms based on a detected change in the spatial positioning of the plurality of flexible robotic arms and the workpiece during printing.

4. The computer-implemented method of claim 1, further comprising:
dynamically adjusting the functional role assigned to each of the plurality of flexible robotic arms during printing for each successive layer until completion of the workpiece.

5. The computer-implemented method of claim 1, wherein:
engaging portions of the workpiece with the gripping mechanism reduces a need for supplemental support structures during printing.

6. The computer-implemented method of claim 1, wherein the analysis of the digital model further comprises:
identifying regions of the workpiece that require temporary support during printing.

7. The computer-implemented method of claim 1, further comprising:
assigning varying nozzle sizes to the flexible robotic arms to enable printing at resolutions tailored to different portions of the workpiece.

8. The computer-implemented method of claim 1, further comprising:
utilizing vision-based analytics to monitor printing and dynamically reassign a manipulation role to one or more of the flexible robotic arms for repositioning the workpiece based on a detected misalignment or deformation of the workpiece.

9. The computer-implemented method of claim 1, further comprising:
automatically reassigning the functional roles of the flexible robotic arms based on real-time analysis of stress patterns and deformation tendencies in the workpiece to enhance stabilization during printing.

10. The computer-implemented method of claim 1, further comprising:
coordinating multi-material deposition by assigning material-specific extrusion roles to selected flexible robotic arms in accordance with the analyzed geometric and material requirements of the workpiece.

11. A computer program product having one or more computer readable storage media having computer readable program code collectively stored on the one or more computer readable storage media, the computer readable program code being executed by a processor of a computer system to cause the computer system to perform operations comprising:
obtaining a digital model of a workpiece;
analyzing the digital model to determine geometric and material requirements of the workpiece;
assigning, based on the analysis, a functional role to each of a plurality of flexible robotic arms of a three-dimensional printing head, wherein the functional roles include at least one of a material extrusion role and a gripping role; and
actuating the flexible arms concurrently in accordance with their assigned roles to perform one or more of:
depositing material onto a workpiece for forming a designated layer of the workpiece;
engaging portions of the workpiece with a gripping mechanism to provide support to a portion of the workpiece; and
repositioning the workpiece for subsequent material deposition.

12. The computer program product of claim 11, wherein the operation further comprise:
monitoring, via one or more sensors, spatial positioning of the plurality of flexible robotic arms and the workpiece during printing.

13. The computer program product of claim 12, wherein the operation further comprise:
dynamically adjusting the functional role assigned to at least one of the plurality of flexible robotic arms based on a detected change in the spatial positioning of the plurality of flexible robotic arms and the workpiece during printing.

14. The computer program product of claim 11, wherein the operation further comprise:
dynamically adjusting the functional role assigned to each of the plurality of flexible robotic arms during printing for each successive layer until completion of the workpiece.

15. The computer program product of claim 11, wherein:
engaging portions of the workpiece with the gripping mechanism reduces a need for supplemental support structures during printing.

16. The computer program product of claim 11, wherein the analysis of the digital model further comprises:
identifying regions of the workpiece that require temporary support during printing.

17. The computer program product of claim 11, wherein the operation further comprise:
assigning varying nozzle sizes to the flexible robotic arms to enable printing at resolutions tailored to different portions of the workpiece.

18. The computer program product of claim 11, wherein the operation further comprise:
utilizing vision-based analytics to monitor printing and dynamically reassign a manipulation role to one or more of the flexible robotic arms for repositioning the workpiece based on a detected misalignment or deformation of the workpiece.

19. The computer program product of claim 11, wherein the operation further comprise:
automatically reassigning the functional roles of the flexible robotic arms based on real-time analysis of stress patterns and deformation tendencies in the workpiece to enhance stabilization during printing.

20. A computing system comprising:
a processor;
a memory coupled to the processor; and
one or more computer readable storage media coupled to the processor, the one or more computer readable storage media collectively containing instructions that are executed by the processor via the memory to cause the processor to perform operations comprising:
obtaining a digital model of a workpiece;
analyzing the digital model to determine geometric and material requirements of the workpiece;
assigning, based on the analysis, a functional role to each of a plurality of flexible robotic arms of a three-dimensional printing head, wherein the functional roles include at least one of a material extrusion role and a gripping role; and
actuating the flexible arms concurrently in accordance with their assigned roles to perform one or more of:
depositing material onto a workpiece for forming a designated layer of the workpiece;
engaging portions of the workpiece with a gripping mechanism to provide support to a portion of the workpiece; and
repositioning the workpiece for subsequent material deposition.

21. An apparatus for three-dimensional printing, comprising:
a three-dimensional printing head comprising a plurality of flexible robotic arms, each robotic arm having multi-degree-of-freedom movement capabilities, wherein at least two of the plurality of flexible robotic arms includes a printing nozzle configured to deposit printing material onto a workpiece;
a material supply system operatively coupled to the printing nozzles, the material supply system configured to deliver one or more printing materials to the printing nozzles;
a control system operatively coupled to the three-dimensional printing head, wherein the control system is configured to control the operation of the three-dimensional printing head, the printing nozzles, and the material supply system; and
a plurality of sensors configured to monitor one or more of the workpiece and environmental conditions of the workpiece.

22. The apparatus of claim 21, wherein the control system comprises one or more of:
a calibration system configured to maintain alignment and accuracy of the flexible robotic arms and printing nozzles;
a collision avoidance system configured to prevent interference between the flexible robotic arms, printing nozzles, and gripping mechanisms during operation;
a digital model processor configured to analyze a digital model of the workpiece and generate a printing plan based on geometric and material requirements; and
a machine learning module configured to predict potential printing issues and dynamically adjust printing parameters based on real-time sensor feedback.

23. The apparatus of claim 21, wherein at least one of the plurality of flexible robotic arms includes a gripping mechanism integrated into the flexible robotic arms, the gripping mechanism configured to engage and stabilize portions of the workpiece during printing.

24. The apparatus of claim 21, wherein at least one of the plurality of flexible robotic arms includes a plurality of sensors embedded within the flexible robotic arms, the sensors configured to monitor spatial positioning, applied forces, and printing process parameters.

25. An apparatus for three-dimensional printing, comprising:
a three-dimensional printing head comprising a plurality of flexible robotic arms, each robotic arm having multi-degree-of-freedom movement capabilities, wherein the plurality of flexible robotic arms comprise:
a first flexible robotic arm that includes a first printing nozzle that is configured to deposit a first material onto a workpiece;
a second flexible robotic arm that includes a second printing nozzle that is configured to deposit a second material onto the workpiece; and
a third flexible robotic arm that is configured to grip the workpiece during deposition of one or more of the first material and the second material onto the workpiece;
a multi-material handling system operatively coupled to the first printing nozzle and the second printing nozzle, the multi-material handling system configured to deliver the first material to the first to the first printing nozzle and the second material to the first to the second printing nozzle;
a control system operatively coupled to the three-dimensional printing head, wherein the control system is configured to control the operation of the three-dimensional printing head, the printing nozzles, and the multi-material handling system; and
a plurality of sensors configured to monitor one or more of the workpiece and environmental conditions of the workpiece.
